(19) United States
(12) Patent Application Publication
(10) Pub. No.: US 2016/0097345 A1
(43) Pub. Date: Apr. 7, 2016

(54) TURBOCHARGED ENGINE AND A METHOD OF MAKING SAME

(71) Applicant: Ford Global Technologies, LLC, Dearborn, MI (US)

(72) Inventor: Sam Penzato, Bath (GB)

(21) Appl. No.: 14/839,636

(22) Filed: Aug. 28, 2015

(30) Foreign Application Priority Data
Sep. 24, 2014 (GB) 1416813.2
Nov. 17, 2014 (GB) 1420334.3

(51) Int. Cl. F02F 7/00; F02B 37/00; F02F 1/24; F02B 33/40

(52) U.S. Cl. CPC F02F 7/0068; F02B 33/40; F02B 37/00; F02F 7/0053; F02F 1/24; F02F 7/0002

(57) ABSTRACT

A turbocharger for an engine is disclosed having a compressor and a turbine mounted remotely from one another on opposite sides of a major structural component of the engine. As one example, an engine system comprises a cylinder block and a turbocharger including a compressor and turbine rotatably coupled via a drive shaft, where the compressor and turbine are positioned on opposite sides of the cylinder block relative to a crankshaft axis. Further, the drive shaft traverses the cylinder block and is rotatably supported at each end by a bearing supported by a part of the cylinder block.

### CROSS REFERENCE TO RELATED APPLICATIONS

The present application claims priority to United Kingdom Patent Application No. 1416813.2, filed Sep. 24, 2014, entitled, “A Turbocharged Engine and a Method of Making Same,” the entire contents of which are hereby incorporated by reference for all purposes.

### FIELD

Embodiments of the subject matter disclosed herein relate to turbocharged reciprocating piston internal combustion engines and, in particular, to improvements in the location of a turbocharger on an engine.

### BACKGROUND

It is well known to provide an internal engine with a turbocharger to pressurize the air entering the engine so as to improve the performance of the engine in terms of torque output, emissions and combustion efficiency.

A conventional turbocharger comprises a housing having a rotary compressor rotatably supported in a chamber at one end of the housing and a turbine rotatably supported in a chamber at an opposite end of the housing. The turbine and the compressor are driveably connected via a drive shaft supported by a central bearing part of the housing.

The turbine is arranged to receive exhaust gas from the engine and convert the kinetic energy of the exiting exhaust gas into a rotary driving torque that is supplied to the compressor. The compressor receives a supply of air, which may be ambient air or a combination of ambient air and recycled exhaust gas, compresses the supplied air and supplies the compressed air to the engine.

This arrangement produces a number of issues when packaging the turbocharger within an engine bay of a motor vehicle. Firstly the length of the ducts used to connect the turbocharger to the engine and the complexity of these ducts requires compromises to be made. For example, when a traditional turbocharger assembly is positioned in an engine bay it will prioritise either Intake or Exhaust duct length.

Turbochargers are normally placed close to the exhaust side of an engine, in this configuration long inlet ducts are often required to attach the inlet of the compressor to the airbox through which air enters and the compressor outlet to the inlet manifold which is located on the opposite side of the engine in the case of a ‘crossflow’ engine. Such long duct lengths having several disadvantages including, additional material cost, additional mass, additional complexity, reduced package space, reduced crash performance, increased pressure drop thereby resulting in reduced efficiency and increased response time to torque often referred to as “turbo lag.”

Secondly, conventional turbochargers represent a relatively large mass that has to be supported. It will be appreciated that a complete turbocharger assembly has to be rigidly supported by the main engine structure using brackets or by direct mounting to the engine. Thirdly, difficulties in packaging the turbocharger can lead to poor crash performance because the relatively solid turbocharger unit may occupy a ‘space’ that will be impinged by other components during an impact. The presence of the rigid turbocharger in this ‘space’ therefore is likely to increase the transfer of crash energy from the front of the vehicle towards the occupant environment.

Fourthly, the transfer of radiated heat from the engine to the cold compressor side components due to the hot turbine part of the turbocharger being in close proximity and closely attached to the cold compressor part of the turbocharger leading to heat transfer from the turbine to the compressor results in a number of disadvantages including the requirement to use materials for the compressor side components having higher thermal resistance than would otherwise be required resulting in increased material cost, higher charge temperatures from the compressor outlet due to this heating effect resulting in reduced engine efficiency due to the higher charge air inlet temperatures, reduced efficiency due to a need for increased post compressor cooling (intercooling) and thermal fatigue due to the temperature differential between the hot and cold sides of the turbocharger.

### BRIEF DESCRIPTION

In one example it may be possible to provide a turbocharged engine that minimizes the problems associated with the use of a conventional turbocharger.

According to a first embodiment there is provided a turbocharged engine having a crankshaft and a turbocharger, the turbocharger comprising a compressor supplying charge air to at least one intake of the engine, a turbine connected to at least one exhaust of the engine and a drive shaft drivingly connecting the compressor to the turbine, the compressor being located remotely from the turbine on an opposite longitudinal side of a major structural component of the engine and the drive shaft is rotatably supported at each end by a respective bearing and at least one of the bearings is carried by the major structural component of the engine.

The major structural component of the engine may be comprised of one of a cylinder block, a crankcase, a cylinder head and a bank of cylinders.

The compressor may comprise a compressor housing defining a working chamber and a compressor rotor located in the working chamber and the compressor housing is mounted on a longitudinal side of the major structural component of the engine.

The turbine may comprise a turbine housing defining a working chamber and a turbine rotor located in the working chamber and the turbine housing is mounted on a longitudinal side of the major structural component of the engine.

The compressor rotor may be fastened to one end of the drive shaft for rotation therewith and the turbine rotor may be fastened to an opposite end of the drive shaft for rotation therewith. The drive shaft may be arranged at substantially ninety degrees to an axis of rotation of the crankshaft of the engine.

The major structural component of the engine may be a cylinder block defining at least one cylinder and the drive shaft of the turbocharger may extend from one longitudinal side of the cylinder block to an opposite longitudinal side of the cylinder block.

The drive shaft of the turbocharger may traverse the cylinder block in a region of the engine located between the crankshaft and a lower end of the at least one cylinder.

The engine may have a cylinder head having one or more air intakes on one longitudinal side thereof and one or more exhausts on an opposite longitudinal side thereof and the compressor may be located on the same side of the engine as the one or more air intakes of the engine and the turbine may be located the same side of the engine as the one or more exhausts of the engine.

According to a second embodiment there is provided a method of assembling a turbocharger having a compressor housing, a compressor rotor, a turbine housing, a turbine rotor and a drive shaft to an engine having a crankshaft wherein the method comprises providing at least two aligned bearings on the engine for supporting the drive shaft, at least one of the bearings being carried by the major structural component of the engine, attaching one of the turbine rotor and the compressor rotor to one end of the drive shaft, engaging the other end of the drive shaft with the at least two bearings such that the drive shaft is positioned at substantially ninety degrees to an axis of rotation of the crankshaft, attaching the other of the turbine rotor and the compressor rotor to the drive shaft and fastening the compressor and turbine housings to opposite longitudinal sides of a major structural component of the engine.

The major structural component of the engine may be comprised of one of a cylinder block, a crankcase, a cylinder head and a bank of cylinders.

The method may further comprise connecting the compressor to at least one intake of the engine and connecting the turbine to at least one exhaust of the engine.

The method may further comprise balancing the compressor rotor, drive shaft and turbine rotor as a sub-assembly before fitting the sub-assembly to the engine.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE FIGURES

FIG. 1 is a schematic block diagram showing a turbocharged engine constructed in accordance with a first embodiment;

FIG. 2 is a diagrammatic plan view of the turbocharged engine shown in FIG. 1 with a cylinder head of the engine removed;

FIG. 3 is a diagrammatic end view of the turbocharged engine shown in FIGS. 1 and 2 in the direction of the arrow III on FIG. 2;

FIG. 4 is a diagrammatic side view of the turbocharged engine shown in FIGS. 1 to 3 in the direction of the arrow IV on FIG. 2; and

FIG. 5 is a method of assembling a turbocharger to an engine in accordance with a second aspect of the embodiment.

### DETAILED DESCRIPTION

With reference to FIGS. 1 to 4 there is shown a four cylinder engine in the form of an inline four cylinder turbocharged crossflow engine, herein referred to as engine 1.

The engine 1 comprises an engine block 2 to which is attached a cylinder head 3. The engine block 2 may comprise a cylinder block and crankcase formed as a single component or may have separate cylinder block and crankcase components fastened together. In either case the cylinder block defines one or more cylinders and in this case there are four cylinders 2a, 2b, 2c, 2d in each of which is slidingly supported a piston (not shown).

Charge Air enters the engine 1 as indicated by the arrow ‘AI’ via an inlet duct 4. It will be appreciated that the inlet charge air could be ambient air or a mixture of ambient air and recirculated exhaust gas. The inducted charge air is drawn into a compressor 10, is compressed by the compressor 10 and is flowed via duct 5 to an inlet manifold 6 connected to inlet ports (not shown) formed in the cylinder head 3 that constitute air intakes for the engine. The charged air is then drawn into the cylinders of the engine 1 and combusted with fuel causing the pistons located in cylinders 2a to 2d of the engine 1 to move in a reciprocating manner to drive a crankshaft 12 before exiting the cylinder head 3 via exhaust passages as exhaust gas into an exhaust manifold 7. The exhaust gas flows via a duct 8 to an exhaust gas turbine 20 (herein referred to as turbine 20) with which it interacts to provide a driving torque to a drive shaft 15 that is drivingly connected at one end to the turbine 20 and is drivingly connected at an opposite end to the compressor 10. The exhaust gas then flows out of the turbine 20 into an exhaust system 9 that may include various aftertreatment devices for the reduction of noise or emissions and back to atmosphere as indicated by the arrow TO′. Therefore unlike a conventional turbocharger arrangement the compressor 10 and the turbine 20 are spaced apart from one another on opposite longitudinal sides of a major structural component of the engine so that the hot exhaust gasses do not compromise the performance of the compressor 10 and allow lower cost materials to be used for the charge air inlet side components. The major structural component of the engine is in this case a cylinder block 2Z but could alternatively be a crankcase, a cylinder head or a cylinder block of a V engine referred to herein as a ‘bank of cylinders’. By mounting the compressor 10 and the turbine 20 on a crossflow engine in such a manner, the distance between the compressor 10 and the inlet ports of the engine 1 is much reduced compared to a conventional turbocharger mounted on the exhaust side of the engine because the compressor 10 is located close to the inlet manifold 6 and the length of any ducts 5 is greatly reduced. In the case of a conventional turbocharger the ducting from the compressor to the inlet side of the engine has to either go around one end of the engine or over the top of the engine. In either case valuable packaging space is taken up and the resulting long duct run results in increased friction losses and reduced compressor efficiency.

The drive shaft 15 runs in this case through the cylinder block 2Z of the engine 1 and is supported via compressor bearing 16 and turbine bearing 17 by the structure of the cylinder block 2Z. The working chambers for the compressor 10 and the turbine 20 are formed by housings 10h, 20h that are fixed directly to longitudinal sides of the cylinder block 2Z by means of fasteners without the need for brackets or any other support structure. Thus, the drive shaft 15 extends from the compressor on one side of the cylinder block, across the cylinder block, and to the turbine on the opposite side of the cylinder block.

The drive shaft 15 is positioned above the position of the crankshaft 12 but below the lower end of the cylinders 2a to 2d in a cylinder block 2Z of the engine block 2.

The length of the drive shaft 15 as well as its position within the engine block 2 reduces significantly the transfer of heat from the turbine 20 to the compressor 10.
It will however be appreciated that the drive shaft could be positioned in other locations such as in a crankcase region of the engine 1 between two cylinders or in the cylinder head 3 of the engine.

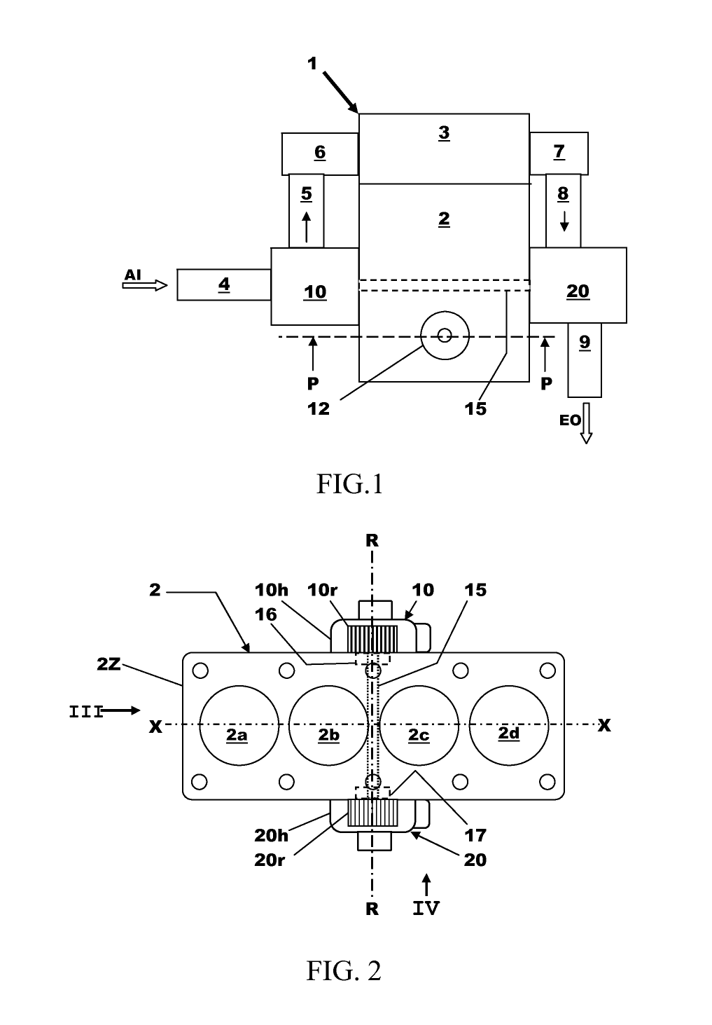

With particular reference to FIGS. 2 to 4 the four cylinders 2a to 2d are shown arranged in an inline fashion in an upper part of the engine block 2 referred to as the cylinder block 2Z of the engine 1. Although not specifically shown in the figures the cylinder block 2Z includes a number of integral cooling passages and oilways to cool the engine 1 and supply oil to the moving parts of the engine 1.

The cylinder block 2Z has in addition to the two longitudinal sides, a substantially flat face at an upper end to which, in use, the cylinder head 3 is secured as is well known in the art. At a lower end of the cylinder block 2Z a number of support saddles (not shown) are formed for supporting, in this case, five main bearings used to rotatably support the crankshaft 12. It will be appreciated that the crankshaft 12 could alternatively be supported by three main bearings. US2014/0041618, for example, shows a four cylinder engine having only three main bearings.

The crankshaft 12 has four throws 12t corresponding to the cylinders 2a to 2d. Each of the throws 12t includes a big end bearing surface or crank pin 12b used for rotatably connecting a connecting rod (not shown) to the crankshaft 12 as is well known in the art.

The crankshaft 12 rotates about a longitudinal axis of rotation X-X defined by main bearings of which bearing journals 12m formed on the crankshaft 12 form a part. The longitudinal axis of rotation X-X of the crankshaft 12 is located vertically on a transverse plane P-P of the engine block 2 and the crankshaft 12 extends in a lengthwise or longitudinal direction of the engine block 2.

The charge air compressor 10 includes the housing 10h that is mounted on a first longitudinal side of the cylinder block 2Z. The compressor housing 10h defines a working chamber in which is rotatably mounted a compressor rotor 10r.

The turbine 20 includes the housing 20h that is mounted on a second, longitudinal side of the cylinder block 2Z, opposite to the first side upon which the compressor housing 10h is mounted. The turbine housing 20h defines a working chamber in which is rotatably mounted a turbine rotor 20r.

The compressor rotor 10r is driveably attached to one end of the drive shaft 15 and the turbine rotor 20r is driveably attached to the other end of the drive shaft 15. In some case the drive shaft 15 and the turbine rotor 20r are formed as a single component.

The drive shaft 15 is supported at said one end by a compressor bearing 16 and at said other end by a turbine bearing 17. A further intermediate bearing for the drive shaft 15 may be provided if required.

The compressor bearing 16 rotatably supports the drive shaft 15 near to the compressor rotor 10r and the turbine bearing 17 rotatably supports the drive shaft 15 near to the turbine rotor 20r. The compressor and turbine bearings, 16 and 17, respectively, are supported by part of the structure forming the cylinder block 2Z and, in this case, are press fitted into a transverse bore formed in the cylinder block 2Z. The mountings for the compressor and turbine bearings 16 and 17, respectively, are therefore formed as part of the structure of the cylinder block 2Z.

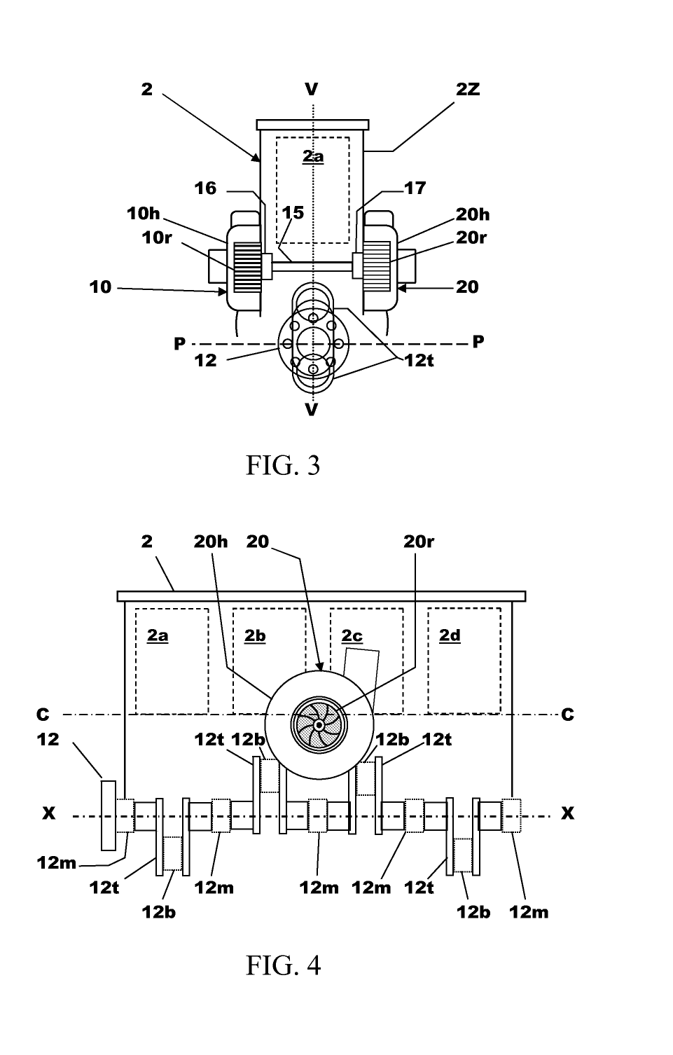

The drive shaft 15 is in this case positioned vertically in a region defined at a lower end by the plane P-P (plane P-P seen in FIG. 3) and at an upper end by a plane C-C (plane C-C seen in FIG. 4) located at the lower end of the cylinders 2a to 2d (cylinders 2a to 2d seen in FIG. 4).

Advantageously, the drive shaft 15 is located close to the plane C-C so as to minimize the distance from the turbine 20 to the exhaust ports of the engine 1. The exact positioning will depend upon several factors including, but not limited to, the size of the turbine 20 and the available space in the engine compartment.

The drive shaft 15 is located in a longitudinal direction of the engine 1 so that it is aligned with, in this case, a central one of the main bearings 12m of the engine 1. In all cases the longitudinal positioning of the drive shaft 15 should be such that it is offset from the throws 12t of the crankshaft 12 so that no interference occurs with connecting rods (not shown) used to connect the crankshaft 12 to the pistons of the engine 1.

It will be appreciated that, although the drive shaft 15 is in the example shown is located between cylinders 2b and 2c, the drive shaft 15 could alternatively be located between cylinders 2a and 2b, between cylinders 2c and 2d or at the longitudinal ends of the engine 1. However, central mounting is advantageous for a crossflow engine as this normally provides the shortest distance between the compressor 10 and the inlet manifold 6 and the shortest distance between the exhaust manifold 7 and the turbine 20.

The rotational axis R-R of the drive shaft 15 (See FIG. 2) is arranged at substantially ninety degrees with respect to the longitudinal axis of rotation X-X of the crankshaft 12 so that it extends transversely through the engine block 2 from one side of the cylinder block 2Z to an opposite side of the cylinder block 2Z. The rotational axis R-R of the drive shaft 15 is also arranged at substantially ninety degrees to a vertical plane V-V (See FIG. 3) extending upwardly from the axis of rotation X-X of the crankshaft 12. It will be appreciated that the cylinder block 2Z does not need to be vertically arranged in use and that if rotated from the vertical the orientation of the plane V-V would no longer be vertical.

Therefore the above-described system provides a split turbocharger having separate compressor and turbine units that a drivingly connected by a drive shaft that extends transversely across the engine so as to be arranged at substantially ninety degrees to a longitudinal axis of a crankshaft of the engine. This turbocharger arrangement is particularly advantageous for crossflow engines but could also be used on other types of engine having inlet and exhaust ports on the same side of the engine.

In the case of a single cylinder engine having a cylinder block, a crankcase and a cylinder head, the compressor and the turbine are positioned on opposite sides of one of the cylinder block, the cylinder head and the crankcase of the engine but in all cases the drive shaft connecting the compressor to the turbine extends transversely of the engine so as to be arranged at substantially ninety degrees to the axis of rotation of the crankshaft.

In the case of a multi-cylinder inline engine having a cylinder block, a crankcase and a cylinder head, the compressor and the turbine are positioned on opposite sides of one of the cylinder block, the cylinder head and the crankcase of the engine but in all cases the drive shaft connecting the compressor to the turbine extends transversely of the engine so as to be arranged at substantially ninety degrees to the axis of rotation of the crankshaft.

In the case of a multi-cylinder engine having more than one bank of cylinders, a common crankcase and a cylinder head for each bank of cylinders, the compressor and turbine are positioned on opposite sides of one of each bank of cylinders, each cylinder head and the crankcase of the engine but in all cases the drive shaft connecting the compressor to the turbine extends transversely of the engine so as to be arranged at substantially ninety degrees to the axis of rotation of the crankshaft.

It will be appreciated that there could be more than one split turbocharger fitted to an engine

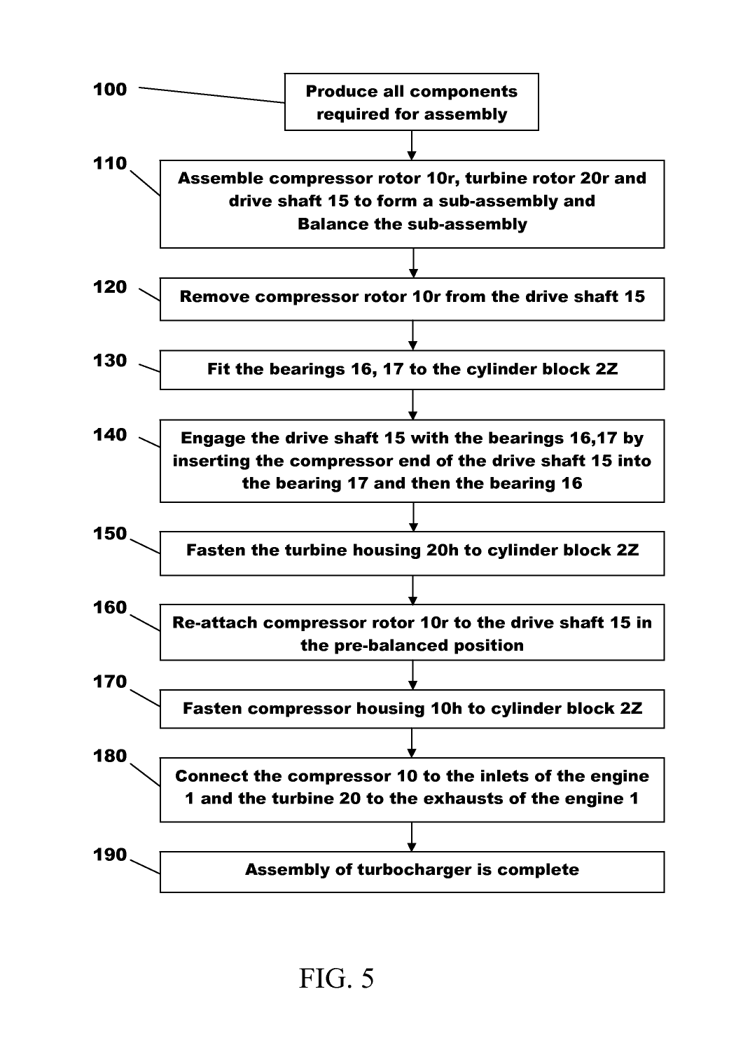

With particular reference to FIG. 5 there are shown the basic steps of a method for assembling a split turbocharger to the engine 1 shown in FIGS. 1 to 4.

The method starts in box 100 where all the necessary parts are produced ready for assembly. In step 110 the compressor rotor 10r, the drive shaft 15 and the turbine rotor 20r are assembled to form a sub-assembly.

The drive shaft and rotor sub-assembly is then placed in a balancing machine and rotated at speed so as to balance the sub-assembly. Then, after balancing of the sub-assembly has taken place, the compressor rotor 10r is removed from the drive shaft 15 as indicated in box 120. In box 130 it is indicated that the compressor and turbine bearings 16 and 17, respectively, are fitted to the cylinder block 2Z. This is done by press fitting the compressor and turbine bearings 16 and 17, respectively, into aligned bores already formed in the cylinder block 2Z. It will be appreciated that this step could be carried out before steps 110 and 120 if preferred or at the same time.

Then in step 140 the drive shaft 15 is inserted compressor end first into the turbine bearing 17 and then into the compressor bearing 16 so as to position the drive shaft 15 in its correct position in the cylinder block 2Z.

The turbine housing 20h is then fastened to a longitudinal side of the cylinder block 2Z as indicated in box 150. Following on from this, in box 160 the compressor rotor 10r is re-attached to the drive shaft 15 in a position corresponding to the position where it was positioned when the sub-assembly was balanced.

The compressor housing 10h is then positioned onto the opposite longitudinal side of cylinder block 2Z to the location of the turbine 20 and is fastened in position as indicated in box 170.

The final stage of the assembly method is to connect the compressor 10 and the turbine 20 to the inlet manifold 6 and exhaust manifold 7 of the engine 1 as indicated in box 180 resulting in the completion of the assembly of the split turbocharger to the engine 1 as indicated in box 190.

It will be appreciated that the above referred to method relates to the assembly of a split turbocharger to an inline engine in a case where the drive shaft extends through a cylinder block of the engine. If the drive shaft were to be located elsewhere on the engine then it will be appreciated that the method would need to be modified to take account of this by, for example, replacing the words ‘cylinder block’ in the disclosed method with words corresponding to the position of the drive shaft such as for example ‘cylinder head’ or ‘crankcase’.

Also in steps 120 and 140 the method describes the removal of the compressor rotor 10r from the drive shaft 15 and the insertion of the compressor end of the drive shaft into the compressor bearing 16 and turbine bearing 17, however it will be appreciated that the turbine rotor 20r could be removed and the turbine end of the drive shaft 15 be inserted into the compressor and turbine bearings, 16 and 17, respectively. In which case the steps indicated in boxes 150 to 170 would also be different in that the compressor housing 10h would then be fastened in position first, the turbine rotor 20r would then be re-fitted and finally the turbine housing 20h would be fastened in place. However the method shown in FIG. 5 may be used in some examples because it may be desirable to permanently fix the turbine rotor 20r to the drive shaft 15 by, for example and without limitation, welding. Also the turbine rotor 20r could be made as one with the drive shaft 15.

The term ‘crossflow engine’ as meant herein is an engine in which the inlets and exhausts for the engine are on opposite sides of the engine or on opposite sides of each bank of cylinders if the engine has more than one bank of cylinders. With such a ‘crossflow’ arrangement the flow of gas is from one side of the engine or bank of cylinders through the engine or bank of cylinders to the other side of the engine or bank of cylinders. In the case of a crossflow engine having two banks of cylinders arranged in ‘V’ formation such as, for example and without limitation, a V4, V6, V8, V10 or V12 engine it is common for the inlets for both banks of cylinders to be located within the ‘V’ on inner sides of the two banks forming the ‘V’ and for the exhausts to be located on outer sides of the two banks forming the ‘V’. Therefore with such an arrangement the engine could be fitted with two split turbochargers one for each bank of cylinders with both of the compressor being located within the “V” of the engine and the two turbines being located on the outer longitudinal sides of the engine.

Note that the example control and estimation routines included herein can be used with various engine and/or vehicle system configurations. The control methods and routines disclosed herein may be stored as executable instructions in non-transitory memory and may be carried out by the control system including the controller in combination with the various sensors, actuators, and other engine hardware. The specific routines described herein may represent one or more of any number of processing strategies such as event-driven, interrupt-driven, multi-tasking, multi-threading, and the like. As such, various actions, operations, and/or functions illustrated may be performed in the sequence illustrated, in parallel, or in some cases omitted. Likewise, the order of processing is not necessarily required to achieve the features and advantages of the example embodiments described herein, but is provided for ease of illustration and description. One or more of the illustrated actions, operations and/or functions may be repeatedly performed depending on the particular strategy being used. Further, the described actions, operations and/or functions may graphically represent code to be programmed into non-transitory memory of the computer readable storage medium in the engine control system, where the described actions are carried out by executing the instructions in a system including the various engine hardware components in combination with the electronic controller. It will be appreciated that the configurations and routines disclosed herein are exemplary in nature, and that these specific embodiments are not to be considered in a limiting sense, because numerous variations are possible. For example, the above technology can be applied to V-6, I-4, I-6, V-12, opposed 4, and other engine types. The subject matter of the present disclosure includes all novel and non-obvious combinations and sub-combinations of the various systems and configurations, and other features, functions, and/or properties disclosed herein.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A turbocharged engine having a crankshaft and a turbocharger, the turbocharger comprising a compressor supplying charge air to at least one intake of the engine, a turbine connected to at least one exhaust of the engine and a drive shaft drivingly connecting the compressor to the turbine, the compressor being located remotely from the turbine on an opposite longitudinal side of a major structural component of the engine wherein the drive shaft is rotatably supported at each end by a respective bearing and at least one of the bearings is carried by the major structural component of the engine.

2. An engine as claimed in claim 1, wherein the major structural component of the engine is comprised of one of a cylinder block, a crankcase, a cylinder head and a bank of cylinders.

3. An engine as claimed in claim 2, wherein the compressor comprises a compressor housing defining a working chamber and a compressor rotor located in the working chamber and the compressor housing is mounted on a longitudinal side of the major structural component of the engine.

4. An engine as claimed in claim 3, wherein the turbine comprises a turbine housing defining a working chamber and a turbine rotor located in the working chamber and the turbine housing is mounted on a longitudinal side of the major structural component of the engine.

5. An engine as claimed in claim 4, wherein the compressor rotor is fastened to one end of the drive shaft for rotation therewith and the turbine rotor is fastened to an opposite end of the drive shaft for rotation therewith.

6. An engine as claimed in claim 1, wherein the drive shaft is arranged at substantially ninety degrees to an axis of rotation of the crankshaft of the engine.

7. An engine as claimed in claim 1, wherein the major structural component of the engine is a cylinder block defining at least one cylinder and the drive shaft of the turbocharger extends from one longitudinal side of the cylinder block to an opposite longitudinal side of the cylinder block.

8. An engine as claimed in claim 7, wherein the drive shaft of the turbocharger traverses the cylinder block in a region of the engine located between the crankshaft and a lower end of at least one cylinder.

9. An engine as claimed in claim 1, wherein the engine has a cylinder head having one or more air intakes on one longitudinal side thereof and one or more exhausts on an opposite longitudinal side thereof and wherein the compressor is located on a same side of the engine as the one or more air intakes of the engine and the turbine is located on a same side of the engine as the one or more exhausts of the engine.

10. A method of assembling a turbocharger having a compressor housing, a compressor rotor, a turbine housing, a turbine rotor and a drive shaft to an engine having a crankshaft, wherein the method comprises providing at least two aligned bearings on the engine for supporting the drive shaft, at least one of the bearings being carried by the major structural component of the engine, attaching one of the turbine rotor and the compressor rotor to one end of the drive shaft, engaging the other end of the drive shaft with the at least two bearings such that the drive shaft is positioned at substantially ninety degrees to an axis of rotation of the crankshaft, attaching the other of the turbine rotor and the compressor rotor to the drive shaft and fastening the compressor and turbine housings to opposite longitudinal sides of a major structural component of the engine.

11. A method as claimed in claim 10, wherein the major structural component of the engine is comprised of one of a cylinder block, a crankcase, a cylinder head and a bank of cylinders.

12. A method as claimed in claim 10, wherein the method further comprises connecting the compressor to at least one intake of the engine and connecting the turbine to at least one exhaust of the engine.

13. A method as claimed in 10, wherein the method further comprises balancing the compressor rotor, drive shaft and turbine rotor as a sub-assembly before fitting the sub-assembly to the engine.

14. An engine system, comprising:
a cylinder block; and
a turbocharger including a compressor and turbine rotatably coupled via a drive shaft, where the compressor and turbine are positioned on opposite sides of the cylinder block relative to a crankshaft axis, where the drive shaft traverses an interior of the cylinder block and is rotatably supported at each end by a bearing, where each bearing is supported by a part of the cylinder block.

15. The engine system of claim 14, wherein each bearing is press fit into a transverse bore formed in the cylinder block and mountings for each bearing are formed as part of the cylinder block.

16. The engine system of claim 14, wherein a rotational axis of the drive shaft is arranged perpendicular to the crankshaft axis.

17. The engine system of claim 14, wherein the drive shaft, along its rotational axis, is arranged centrally between two cylinders of the cylinder block and aligned with a central one of a plurality of main bearings of a crankshaft.

18. The engine system of claim 14, wherein the drive shaft is positioned above a position of a crankshaft and below a lower end of cylinders in the cylinder block.

19. The engine system of claim 14, wherein the compressor includes a compressor housing mounted on a first longitudinal side of the cylinder block, the compressor housing defining a first working chamber in which a compressor rotor is rotatably mounted and wherein the turbine includes a turbine housing mounted on a second longitudinal side of the cylinder block, opposite the first side, the turbine housing defining a second working chamber in a turbine rotor is rotatably mounted.

20. The engine system of claim 19, wherein the compressor rotor is driveably attached to one end of the drive shaft and the turbine rotor is driveably attached to an opposite end of the drive and wherein a compressor bearing rotatably supports the drive shaft near to the compressor rotor and a turbine bearing rotatably supports the drive shaft near to the turbine rotor, where the compressor bearing and turbine bearing are supported are supported by part of the cylinder block.
